(19) United States
(12) Patent Application Publication
(10) Pub. No.: US 2010/0325207 A1
(43) Pub. Date: Dec. 23, 2010

(54) CONDITIONAL COMMUNICATION ACCESS BASED ON USER STATUS

(75) Inventors: Elizabeth F. Churchill, San Francisco, CA (US); Ron Martinez, San Francisco, CA (US); Athellina Athsani, San Jose, CA (US)

Correspondence Address: Yahoo! Inc.;c/o Frommer Lawrence & Haug LLP, 745 Fifth Avenue, NEW YORK, NY, 10151, US

(73) Assignee: Yahoo! Inc., Sunnyvale, CA (US)

(21) Appl. No.: 12/488,380

(22) Filed: Jun. 19, 2009

(51) Int. Cl. G06F 15/16

(52) U.S. Cl. 709/204

(57) ABSTRACT

A device, system and method to enable communications over a network that allows a user to establish a status that controls the method or manner of communication to client devices of the user based on various definable conditions, and to track such communications based on the condition-related status of various users to discern behavior or gauge progress towards an objective.

### TECHNICAL FIELD

The present invention relates generally to conditional communication access, and more particularly, but not exclusively to enabling users to control communication access based on various definable conditions and a condition-related status of the user, as well as to discern behavior or gauge progress towards a common goal or objective of members in a group.

### BACKGROUND

The development and expansion of the Internet and wireless networks has given rise to a number of ways for people to communicate. Many people have a desktop computer, a cellular phone, a regular phone, a laptop computer, a PDA and/or Blackberry. For many of these devices, there are several ways of contacting the individual, such as through a work or personal phone number, a work or personal e-mail address, through instant messaging, through text messaging or through various other methods of communication such as Facebook, Twitter, AIM, ICQ, IRC, or the like.

These different methods provide many opportunities and ease the ability to communicate and connect with others. However, at times these many forms of communication can be distracting and time consuming to keep track of. For example, making arrangements with a group of friends can be difficult because communication with certain individuals may only be by e-mail while for other individuals communication may only be available through cellular phone or text messaging. It is also difficult to coordinate schedules for many individuals, or determine the mindset of individuals with respect to whether they are available for communications or communication-related activities. Moreover, the various forms of communication can be distracting to people while engaging in other activities. For example, receiving a cellular telephone call when the cellular phone is not in a hands-free mode while driving may not only be a distraction but potentially dangerous and in violation of driving rules. As another example, receiving calls and instant messages from non-work related individuals during work hours can result in low productivity.

Another aspect of these many forms of communication is that it is difficult to ascertain information, such as the status or progress towards a common goal or patterns of communication. For some forms of communication, such as instant messaging, the contacts are transitory. For other forms, there may be records of the communication, such as phone logs and the like, but making use of such records, especially in conjunction with other forms of communication, is difficult. Some individuals do not provide information on their availability, while others provide frequent updates through instant messaging, e-mails or websites such as Twitter. Determining information or patterns of communication can be useful in analyzing work habits, how time is spent or progress towards a common goal among individuals. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a mobile device that may be included in a system implementing the invention;

FIG. 3 shows one embodiment of a network device that may be included in a system implementing the invention;

FIG. 4 shows one embodiment of a flow diagram for the registration of a user of the system;

FIG. 5 shows one embodiment of a selection interface screen that permits the creation of a new status for a user;

FIG. 6 illustrates one embodiment of a status control interface screen usable to permit a selection of a condition-related status for a user;

FIG. 7 illustrates one embodiment of a flow diagram usable in processing of communications to a user;

FIG. 8 illustrates one embodiment of an interface screen usable in creation of a community group;

FIG. 9 shows one embodiment of an interface screen usable in setting conditions for an objective of a community group;

FIG. 10 illustrates one embodiment of a flow diagram for generating a comparison between a condition-related status of a group and a common objective of the group;

FIG. 11 shows one embodiment of an interface screen usable in setting parameters for a presentation of a comparison between the condition-related status of a group and the common objective of the group;

FIG. 12 shows one embodiment of a visual presentation of a community group in relation to a common objective of the group;

FIG. 13 shows another embodiment of a visual presentation of a community group in relation to a common objective of the group;

FIG. 14 shows another embodiment of a visual presentation of a community group in relation to a common objective of the group;

FIG. 15 shows another embodiment of a visual presentation of a community group in relation to a common objective of the group; and

FIG. 16 shows another embodiment of a visual presentation of a community group in relation to a common objective of the group.

### DETAILED DESCRIPTION

The present invention now will be described more fully hereinafter with reference to the accompanying drawings, which form a part hereof, and which show, by way of illustration, specific embodiments of the invention. However, this invention may be embodied in many different forms and should not be construed as limited to the embodiments set forth herein. Rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. Therefore, the following detailed description is not to be taken in a limiting sense.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments of the invention may be readily combined without departing from the scope or spirit of the invention.

As used herein, “communication access conditions” refer to a set of conditions or requirements that are applied to control communication access to a user or members of a group, and may be applied to multiple forms of communication. The communication access conditions may be system-default conditions, user created conditions, routine-driven system-derived conditions, or the like.

The following briefly describes the embodiments of the invention to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly described, various embodiments are directed towards enabling users to manage conditional communication access controls for themselves, and/or groups of users, and to manage various communication goals and conditions for the goals. Thus, some embodiments, enable users to establish a status that may be appended with communication access conditions to individual contacts and/or groups of contacts to control communication access to users and/or groups of users, and to track such communications based on condition related status of various users to discern behavior and/or to gauge progress toward an objective.

In one embodiment, a user interface is provided that enables users to provide a user profile, including contact information, and to consolidate their social network information. In one embodiment, various system default statuses, as well as routine-driven system derived statuses may also be generated. The user may create various conditional communication settings that can be group based, individual based, contextual based, routine based, and/or condition based. Conditions, events, and the like may then be monitored, and communications may be managed for the user based on the conditions and/or statuses detected. For example, various created conditions may be paired with contextual information surrounding a user and/or group of users, to detect when to apply a communication access control. Moreover, in various embodiments, behavior and routine patterns may be aggregated, and automatic suggestions may be provided on communication access controls based on the patterns and/or aggregated behaviors. Thus, in one embodiment, user patterns may be monitored or learned by various embodiments to designate communication hotspots, communication behaviors, and possible communication conditions.

In one embodiment, users may be enabled to override communication access controls, and or place additional conditions on the communication access settings. As described, users may set communication access controls to the user and/or groups of users based on conditions that the user created, and/or those conditions automatically created.

In other embodiments, users may garner communication availability of multiple individuals in a single entity, such as a group, community or the like. Then based on communication activities, patterns, or other social networking information monitored, embodiments may discern various flocking or other types of behaviors of the groups engaged in similar and/or relevant activities, and provide communication recommendations to the users, groups, or the like. Thus, communication access control to a communication may be based on status and/or condition aggregations. Users may review communication availability of other users, and/or groups of users, review communication statuses of other users, and/or groups of users. Using such group information, users may be enabled to create entity group communication goals and/or conditions for the goals. In some embodiments, aggregated statuses, patterns, and the like, may be employed to provide automated suggestions on group goals, user communication access, and/or conditions of communication access for other users, and/or groups of users. For example, in one embodiment, group goals may be automatically created. Various other mechanisms for managing conditional communication access to a user and/or group of users are described further herein.

### Illustrative Operating Environment

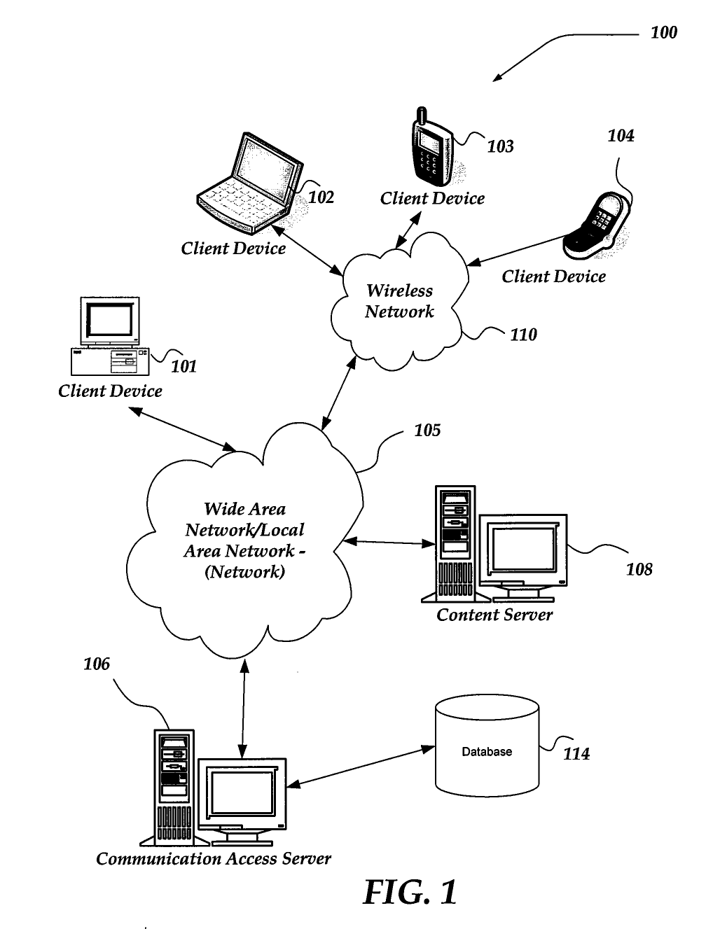

The following describes various configurations for which embodiments may be practiced. Such configurations are not to be construed as limiting, however, and other arrangements may be used. FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, wireless network 110, client devices 101-104, communication access server 106, and content server 108.

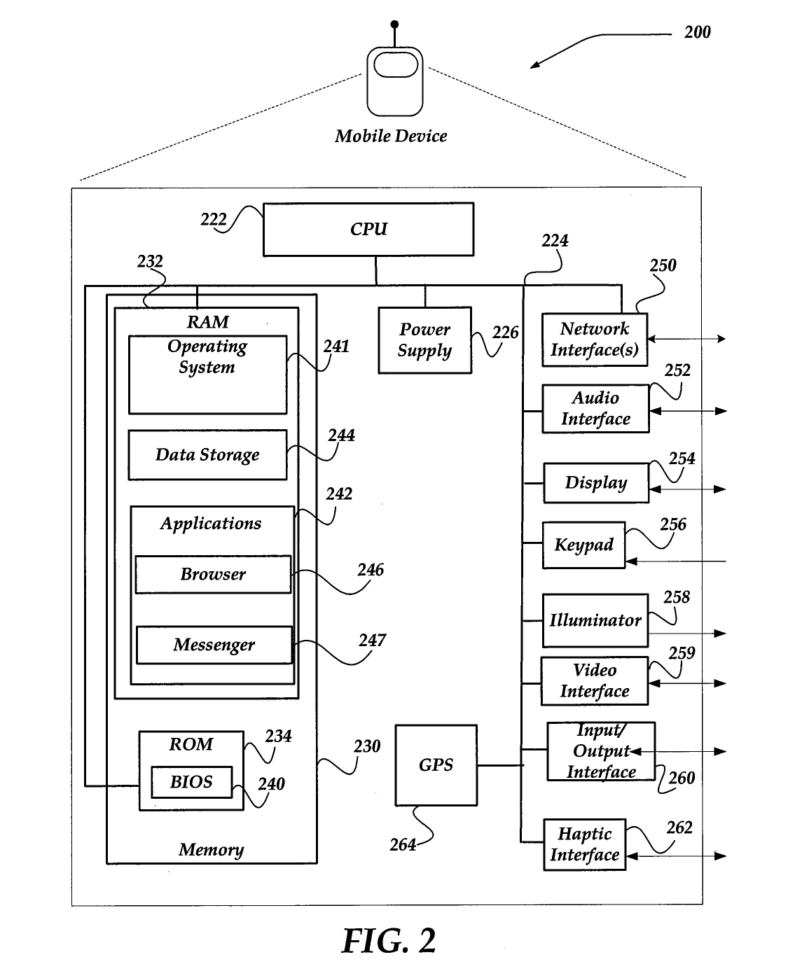

Generally, client devices 102-104 may include virtually any mobile computing device capable of receiving and sending communications over a network, such as wireless network 110, or the like. Such devices include portable devices such as, cellular telephones, smart phones, pagers, radio frequency (RF) devices, infrared (IR) devices, Personal Digital Assistants (PDAs), handheld computers, laptop computers, wearable computers, tablet computers, integrated devices combining one or more of the preceding devices, or the like. One embodiment of a mobile device usable as one of client devices 102-104 is described in more detail below in conjunction with FIG. 2.

Client device 101 may include virtually any computing device that typically connects using a wired communications medium such as personal computers, multiprocessor systems, microprocessor-based or programmable consumer electronics, network PCs, or the like. In one embodiment, client devices 101-104 may be configured to operate over a wired and/or a wireless network.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send web pages, web-based messages, or the like. The browser application may be configured to receive and display graphics, text, multimedia, or the like, employing virtually any web based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send communications.

Client devices 101-104 also may include at least one other client application that is configured to receive content from another computing device. The client application may include a capability to provide and receive textual content, multimedia information, or the like. The client application may further provide information that identifies itself, including a type, capability, name, or the like. In one embodiment, client devices 101-104 may uniquely identify themselves through any of a variety of mechanisms, including a phone number, Mobile Identification Number (MIN), an electronic serial number (ESN), network address, or other device identifier. The information may also indicate a content format that the client device is enabled to employ. Such information may be provided in a communication, or the like, sent to another computing device.

Client devices 101-104 may also be configured to communicate through email, Short Message Service (SMS), Multimedia Message Service (MMS), instant messaging (IM), internet relay chat (IRC), Mardam-Bey's IRC (mIRC), Jabber, or the like, with and between another computing device. However, the present invention is not limited to these communication protocols, and virtually any other communication protocol may be employed. Client devices, such as client device 112, may be configured to implement transmission of voice through the internet or other packet-switched networks through Voice-over-Internet protocol (VoIP).

Client devices 101-104 may further be configured to include a client application that enables the user to log into a user account that may be managed by another computing device, such as content server 108, communication access server 106, or the like. Such user account, for example, may be configured to enable the user to receive emails, send/receive IM messages, SMS messages, access selected web pages, participate in a social networking activity, provide messages that may include links or attachments, or the like. However, managing of communications may also be performed without logging into the user account.

One example of an account managed by another computing device, such as content server 108, is Twitter. Twitter is a social networking and micro-blogging service that allows users to send “updates” (or “tweets”; text-based posts, up to 140 characters long) to the Twitter web site, via the Twitter web site, short message service (SMS), instant messaging, or a third-party application such as Twitterrific or Facebook. Updates are displayed on the user's profile page and instantly delivered to other users who have signed up to receive them. The sender can restrict delivery to those in his or her circle of friends (delivery to everyone is the default). Users can receive updates via the Twitter website, instant messaging, SMS, Really Simple Syndication (RSS), email or through an application.

Wireless network 110 is configured to couple client devices 102-104 with network 105. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, or the like. Access technologies such as 2G, 3G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 105 is configured to couple communication access server 106 and its components with other computing devices, including, content server 108, client device 101, and through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

Additionally, communication media typically embodies computer-readable instructions, data structures, program modules, or wired media such as twisted pair, coaxial cable, fiber optics, wave guides, and other wired media and wireless media such as acoustic, RF, infrared, and other wireless media.

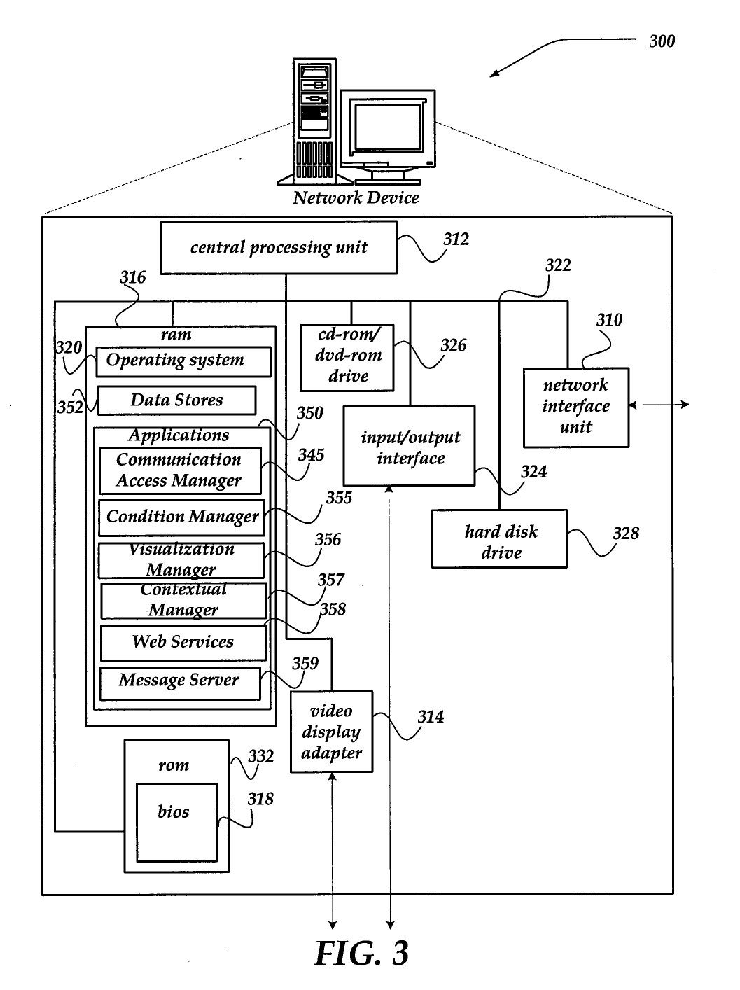

One embodiment of communication access server 106 is described in more detail below in conjunction with FIG. 3. Briefly, however, communication access server 106 may include any computing device capable of connecting to network 105 to enable managing of communications to and from a user. In one embodiment, communication access server 106 may provide an interface to a user of client devices 101-104 that may be used to post, spread, delete, or otherwise manage communications' access and/or communication goals.

In one embodiment, a user employs the interface to register with communication access server 106 by providing information about the user including such things as their name, address, contacts, e-mail account information including login name and password, telephone numbers, the name and passwords used in other accounts such as Facebook accounts, Twitter accounts, Yahoo! instant message accounts and the like. Embodiments are not limited to these example accounts, or communication mechanisms, and others may be employed. The user's contacts may be derived from an on-line address book, a client resident address book, or any other mechanism configured to manage addresses. This information may be used such that all communications to and from each of these communication sources to the user may be controlled or processed by communication access server 106. Since the communications are routed through communication access server 106, the communications to the user may be subject to conditions or restrictions, and the methods, manners and at times content of communication can be controlled by setting various conditions.

In another embodiment, communication access server 106 may be set as the communications hub for the various methods of communication by re-setting destination settings with some or all of the methods of communication. For example, for e-mail accounts, the user may set the e-mail accounts to automatically forward all e-mail messages for the user to communication access server 106, which would then process the messages in accordance to the communication access controls in place within the system. As another example, telephone calls, either cellular, landline or VoIP-type communications, and/or virtually any other form of communications enabled by client devices 101-104, may be controlled by, forwarded or passed through communication access server 106, even though the service is provided externally from communication access server 106. Communication access server 106 may consolidate and store the information.

Communication access server 106 further enables the user to create condition-related statuses. Communication access server 106 may also create condition-related statuses for the user based on the registration and profile information, or based on communication-related data obtained from the user over a course of time. A set of one or more communication access conditions may be associated with each of the condition-related statuses, and applied to communications when the status of the user is set accordingly.

The user or communication access server 106 may further set the condition-related status to be applied to communications with the user. Communication access server 106 may process the communications with the user in accordance with the communication access conditions associated with the condition-related status.

Communication access server 106 may also store information relating to various information about communications to and from individuals or groups of individuals. Communication access server 106 may gather information and store information tracking which individuals contact each other, the time, duration and type of contact, whether the contact relates to specific community goals, tracks user defined conditions for communications, and may gather other information relating to the content of the communications. Alternatively, and/or in addition, the information may be stored external from communication access server 106 in database 114. Communication access server 106 may analyze the contacts to determine patterns of communications or conduct, and may provide users with graphical representations of these patterns.

Using the interface provided by communication access server 106, a user may be able to restrict, allow, or control certain types of communication. For example, the user may choose temporal controls on when communications are restricted or allowed including duration, seasonal periods or time of day. The user may condition communication based on contextual information such as, for example, the status of other users within the system, the user's contact names, contact information, contact location or a characteristic of the method of communication. For example, if a user's client device's battery has a low charge, voice-related communications may be forwarded to other forms of communication such as through instant messaging, or the like. In one embodiment, the forwarding may result in converting the communication from a first communication protocol to a second communication protocol, such as from a voice-related protocol to an instant messaging protocol, or the like. As another example of a characteristic of the method of communication acting as a condition, a call to a mobile client device with no headset attached that is determined to be moving rapidly, e.g., a mobile client device in a car, may be sent to voicemail. Yet another example, the user may set an access condition relating to a meeting, such as the need or desire for a meeting or a particular time that a meeting could occur. Communication access server 106 may search for additional users within a particular group of contacts with a similar setting and alert the parties to the meeting through their preferred manners of communication, when a condition-related status is detected.

The communications that take place within or through communication access server 106 can be tracked based on various parameters such as the time or duration of the access, type of communication, identity of the sender of the communication, a characteristic of the sender of the communication, the location of the user or sender of the communication, other similar attributes of the sender, the condition-related status of the user or any other information relating to the communication, the user or the sender of the communication. This information may then be used to analyzed to generate or otherwise identify routines, behavior patterns, or progress towards mutual objectives. The information may be presented to the user in various visual forms for the user to analyze, or may be used by communication access server 106 to generate automated recommendations on communication access controls based on patterns of communication.

As noted, communication access server 106 will keep track of the communications to and from the user. Based on patterns in the communications, communication access server 106 may provide suggestions to the user for conditional access conditions and condition-related statuses. Communication access server 106 may also permit the user to visually display communication information so that a user can determine patterns of behavior based on such information.

In another embodiment, the communication access server 106 can be used to keep track of common objectives of two or more users using the condition-related statuses of the users. Communication access server 106 may visually display the progress of a group of users towards a common goal. Communication access server 106 may also notify one or more users when the group of users has obtained the specified goal or achieved a certain percentage or amount of such a goal.

It should be noted that while FIG. 1 illustrates one use of communication access server 106 to manage communications, the invention is not so limited. For example, as noted above, client devices 101-104 may also be configured with a client application, script, plug-in, widget, applet, or the like, that is configured and arranged to enable the client device to manage communications either to or from a user. Thus, in one embodiment, system 100 may be configured to employ communication access server 106's functions distributed across the plurality of client devices 101-104 in a peer-to-peer configuration, for example. Moreover, in another embodiment, various functions performed by communication access server 106 may be distributed across a plurality of network devices and/or client devices.

Devices that may operate as communication access server 106 may include personal computers, desktop computers, multiprocessor systems, microprocessor-based or programmable consumer electronics, network PCs, servers, or the like.

Content server 108 includes virtually any network computing device that is configured to provide various resources, including content and/or services over network 105. As such, content server 108 represents one embodiment of a content system. Content server 108 may provide access to any of a variety of content, including, but not limited to messages, such as emails, SMS messages, IM messages; search results; news; articles; websites; hyperlinks; ads; reviews; as well as content that may include audio files, video files, text files, streaming files, graphical files, or the like. Thus, virtually any content may be available through content server 108 for access by client devices 101-104. In one embodiment, content server 108 might be configured and arranged to provide a website for users to post, view, link to, and/or otherwise access, content. Content server 108 might also provide FTP services, APIs, web services, database services, or the like, to enable users to access content. In addition, content server 108 may also provide a messaging service, such as an email server, text messaging server, or the like. However, content server 108 is not limited to these mechanisms, and/or content, and others are envisaged as well.

Content server 108 may include an interface that may request information from a user of client devices 101-104. For example, content server 108 may provide access to an account, which may request user log-in information. Such log-in information may include a user name, password, or other identifier of the user and/or client device used by the user. Moreover, content server 108 may also be configured to manage information for a user, such as an address book, buddy list, or other type of contact list. Such contact lists may be made available to communication access server 106, in one embodiment.

Devices that may operate as content server 108 include, but are not limited to personal computers, desktop computers, multiprocessor systems, microprocessor-based or programmable consumer electronics, network PCs, servers, network appliances, and the like. Moreover, while communication access server 106 and content server 108 are illustrated as distinct devices, the invention is not so limited. For example, in one embodiment, communication access server 106 and content server 108 may be implemented within a single network device, or distributed across a plurality of network devices.

### Illustrative Client Environment

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. More, mobile device 200 may represent, for example, one of client devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like. This physical location of the device and/or change in physical location of the device may be used as part of the condition-related status of the user or as part of the condition under which communications may be made with the user.

Mass memory 230 includes a RAM 232, a ROM 234, and other storage means. Mass memory 230 illustrates another example of computer readable storage media for storage of information such as computer readable instructions, data structures, program modules, or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general-purpose operating system such as a version of UNIX, or LINUX™, or a specialized client communication operating system such as Windows Mobile™, the Symbian® operating system, Y! GO, or so forth. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. Memory 230 can also be used to store database information. For example, data storage 244 may also be employed to store information that describes various capabilities of mobile device 200. The information may then be provided to another device based on any of a variety of events, including being sent as part of a header during a communication, sent upon request, or the like. Moreover, data storage 244 may also be employed to store personal information including but not limited to address lists, contact lists, personal preferences, calendars, or the like. Data storage 244 may also include some profile information. At least a portion of the information may also be stored on a disk drive or other storage medium (not shown) within mobile device 200.

Applications 242 may include computer executable instructions which, when executed by mobile device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may also include browser 246 and messenger 247.

Browser 246 may be configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send messages. However, any of a variety of other web based languages may be employed.

Messenger 247 is configured to send, to receive, and/or to otherwise process messages using SMS, MMS, IM, email, VOIP, and/or any of a variety of other messaging communication protocols. Although a single messenger 247 is illustrated, it should be clear that multiple applications might be employed. For example, one messenger application may be configured to manage SMS messages, where another messenger application may manage IM messages, and yet another messaging application is configured to manage emails, or the like.

Although not illustrated, mobile device 200 may include various other applications, or the like, that may be configured to manage, for example, communication access and/or communication goals in a peer-to-peer configuration, or the like. Thus, in one embodiment, applications, downloadable scripts, plug-ins, or the like, may be configured to provide at least some of the functionality of communication access server 106 of FIG. 1.

### Illustrative Network Device Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, communication access server 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer readable storage media. Computer readable storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

RAM 316 may includes one or more data stores 352, which can be utilized by network device 300 to store, among other things, applications 350 and/or other data. RAM 316 can also be used to store database information. For example, data stores 352 may also be employed to store information that describes various user account information, user profiles, communication information, including, but not limited to, user related statuses, system default statuses, routine driven system derived statuses, user created conditions, goals, group information, user interfaces, and the like. At least a portion of the information of data stores 352 may also be stored on a disk drive or other storage medium (not shown) within network device 300, and/or in a remote storage mechanism, such as database 114 of FIG. 1.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, web servers, account management, and so forth. Applications 350 may include web services 358, message server 359, and Communications Access Manager (CAM) 345. As shown, applications 350 may further include condition manager 355, visualization manager 356, and contextual manager 357. It should be noted, that while condition manager 355, visualization manager 356 and contextual manager 357 are illustrated as distinct applications, the invention is not so limited. Thus, in another embodiment, condition manager 355, visualization manager 356 and contextual manager 357 may be components within CAM 345, or hosted on another network device distinct from network device 300.

Web services 358 represent any of a variety of services that are configured to provide content, including messages, over a network to another computing device. Thus, web services 358 include for example, a web server, messaging server, a File Transfer Protocol (FTP) server, a database server, a content server, or the like. Web services 358 may provide the content including messages over the network using any of a variety of formats, including, but not limited to WAP, HDML, WML, SMGL, HTML, XML, cHTML, xHTML, or the like.

Message server 359 may include virtually any computing component or components configured and arranged to forward messages from message user agents, and/or other message servers, or to deliver messages to a local message store, such as data store 352, or the like. Thus, message server 359 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like.

However, message server 359 is not constrained to email messages, and other messaging protocols may be managed by one or more components of message server 359. Thus, message server 359 may also be configured to manage SMS messages, IM, MMS, IRC, mIRC, or any of a variety of other message types. Moreover, message server 359 may also represent a web server configured to enable access to and/or management of messages.

In one embodiment, message server 359 and/or web services 358 may communicate with CAM 345 to enable the conditional communications of the invention. In one embodiment, CAM 345 may provide a script, applet, application, or other downloadable component, to a client device for use in managing the communication access settings and/or determining patterns of communication to or from a user. In another embodiment, CAM 345 may provide information to message server 359 and/or web services 358, including an interface, or the like, for use in displaying, and/or otherwise managing communications. Although not illustrated, in one embodiment, CAM 345 may be configured as a plug-in, or the like, to message server 359 and/or web services 358.

Contextual manager 358 is configured to manage contextual information, including gathering such information, and managing storing of such information. Contextual manager 358 may further perform various analysis of the contextual information to determine location information, route information, whether a user is determined to be traveling in a vehicle, within a proximity to another user or group of users, or the like. Thus, contextual manager 358 is also configured to provide CAM 345 with contextual information that may be used to determine modes of communication based on contextual information surroundings, or the like.

Visualization manager 356 is configured to manage various information that may include aggregated information for various forms of communication, messages, conditions, statuses, or the like, and provide an interface usable to visually represent to a user, such communication information, goals, or the like.

Condition manager 355 is configured to receive and/or manage user created, group created, and/or CAM created conditions, monitor for such conditions, and provide communication access based on a detected condition, for a given context.

CAM 345 is configured to enable a user and/or group of users to set statuses that may then be appended with communication access conditions to individual users and/or groups of users for the purposes of controlling communication access to one or more users, and to further enable a user to garner communication availability of one or more users. CAM 345 also enables users and/or groups of users to engage in similar and/or relevant activities and provide communication recommendations and/or goal status to the users. As noted, CAM 345 may interact with message server 359, web services 358, condition manager 355, visualization manager 356, and contextual manager 357 to perform at least some of its functions.

### Generalized Operation

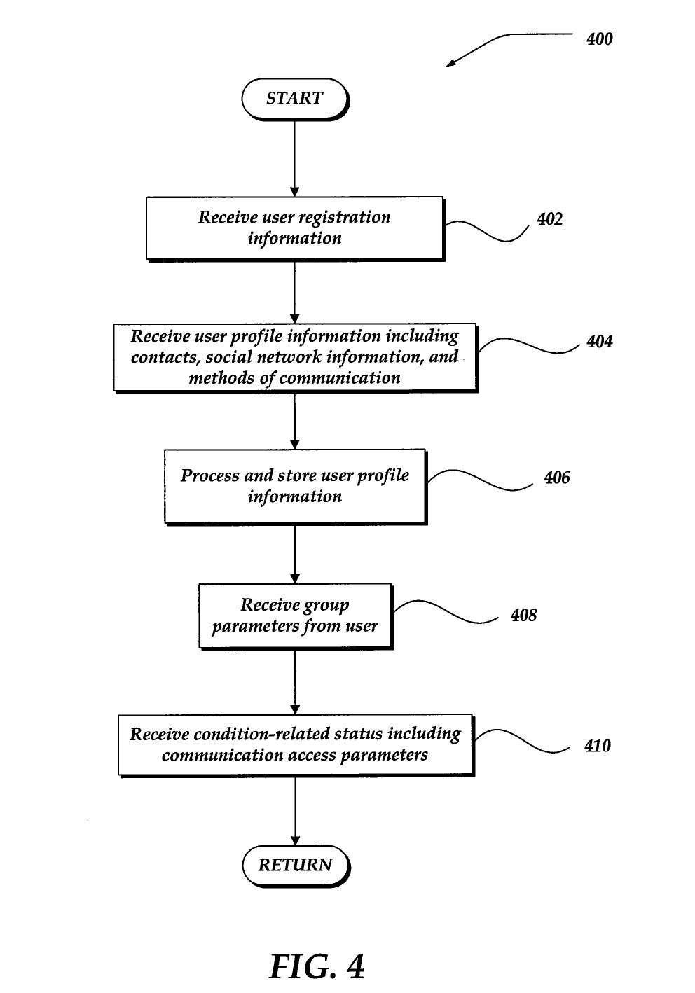

The operation of certain aspects of the invention will now be described with respect to FIG. 4. FIG. 4 illustrates a logical flow diagram generally showing one embodiment of a process for registering and profiling a user, and setting up condition-related status and communication access settings for a user. Process 400 of FIG. 4 may be implemented, for example, within communication access server 106 of FIG. 1, in one embodiment.

Process 400 may begin, after a start block, by a user providing registration information. The registration may include creation of a user name, password, and entry of personal information about the user such as the user's name, address and other similar information. After registration, the user then enters profile information as shown in block 404. The profile information includes the user's contacts, which may be automatically extracted from the user's electronic address book, social network information or the like. The user also enters the various methods of communication available to the user. The methods of communication may be e-mail addresses, VoIP phone numbers, cellular phone numbers, external accounts used for communication such as Facebook and Twitter, instant messaging accounts, and any other electronic based accounts that can be controlled through communication access server 106. For external accounts, the user may also be required to enter user names and passwords for such accounts. The user's registration information and profile information may be consolidated and stored as shown in block 406. Next, in block 408, the user may define groups of users from a list of contacts and/or address books of the user. These groups may have, for example, common interests, goals or tasks. As one example, the user may create a list of co-workers who are friends and engage in social activities such as regularly lunch together. Another example would be a group consisting of immediate family members.

The user may then set up their condition-related status as shown in block 410. The condition-related status may be created by the user, may be a default status set by the system (communication access server 106 of FIG. 1), may be based on a routines derived by the system and may be imposed on the users by a super administrator. The condition-related status might be such things, for example, as “unavailable,” “in transit”, “in a meeting”, “available”, “limited availability,” “available for lunch”, “available for meeting” or “currently in office.” In essence, the status is an indication of the current condition or availability of the user. The status may be user-generated, where the user creates the status and defines the applicable conditions for the status. The status may be generated by the system such as when particular forms of communication, like a cellular phone or other mobile communications device, are not turned on or connected. In such a case, the system may create and may apply a status to the user of “unavailable” in which communications are re-routed to other devices or other forms of communication. As another example, a status for an employee may be “on the way”, where the condition is determined based on the location of a GPS-enabled device. The status may also be generated by a super administrator, wherein the status and conditions are set for a group of users, such as for all employees of a company, which cannot be altered by anyone other then the super administrator. The condition-related status of the user may have duration settings, start time, end time, periodic times, expiration times, and the like. The status may also relate to locations, proximity to locations, devices, conditions of devices (such as, for example, head set availability, ring settings, battery settings and/or IM status settings).

For user generated conditional communication access conditions, the user may therefore, set conditions types based on a duration setting, a location, a communication mode, a device, and/or a variety of other conditions. For example, for device modes conditions, such as noted above, the user might assign a status for the condition, assign the status to applicable groups, and/or even designate an expiration date for the status or condition. In one embodiment, the user may also assign metadata to the status or condition, that might include labels, tags, descriptions, texts, URLs, links, or the like. However, in another embodiment, the system may implement automatically various restrictions on user generated conditions.

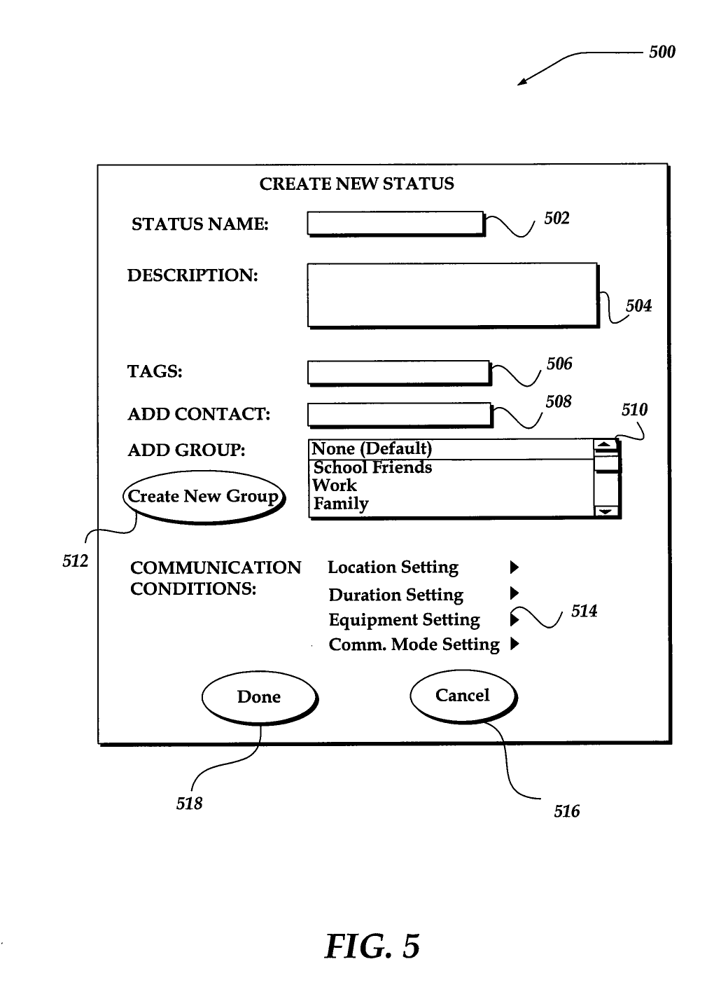

An entry screen for creating a user-defined status is shown in FIG. 5. The user creates a name for the status as shown by text-entry box 502, and provides a description of the status in text-entry box 504. Alternatively, the status name may be set through a drop-down menu which may provide suggestions for names or system-defined statuses. The user may then associate contacts with the status by adding tags, contacts, groups or creating and adding new groups as shown by boxes 506 to 512. The user further selects the communication access conditions that are associated with the particular status as shown by selection menu 514. The communication access conditions may be, for example, temporal, contextual or system-generated. The user may choose to limit communications to a single method of communication such as e-mail or instant messaging to a particular account, or may choose to use all methods of communication. The user may choose which equipment to receive communications or choose the locations which particular equipment is at before communications will be sent. In one embodiment, a user may choose to receive telephone calls via a landline telephone only when the user's cell phone is located within a certain distance of the landline telephone. This would permit the user to receive calls via the landline phone when they are at, for example, their desks but have calls routed to their cellular telephone when the person is away from their desk. This can be accomplished, again for example, by determining the location of the cellular phone via GPS receiver 264 of FIG. 2.

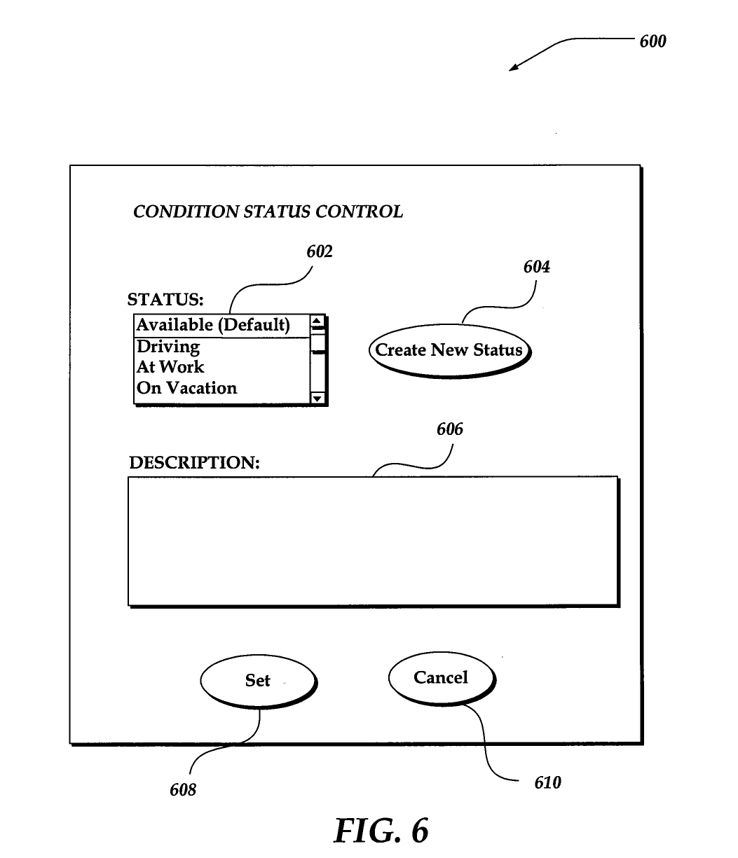

The user may click on done button 518, at which point the system would store the new status thereby completing the registration and setup process of FIG. 4. To employ the system, the user can set the condition-related status as shown by the entry screen of FIG. 6. The user may select the status to be applied by selecting from status selection box 602. If the user desires to add a new status, then the user may select create new status button 604, which would bring the user back to the screen shown in FIG. 5 and the associated steps. Once the status is selected, the associated description of the status may be displayed in description field 606. The user sets the condition-related status by clicking on set button 608, or choose not to reset the status by clicking on cancel button 610.

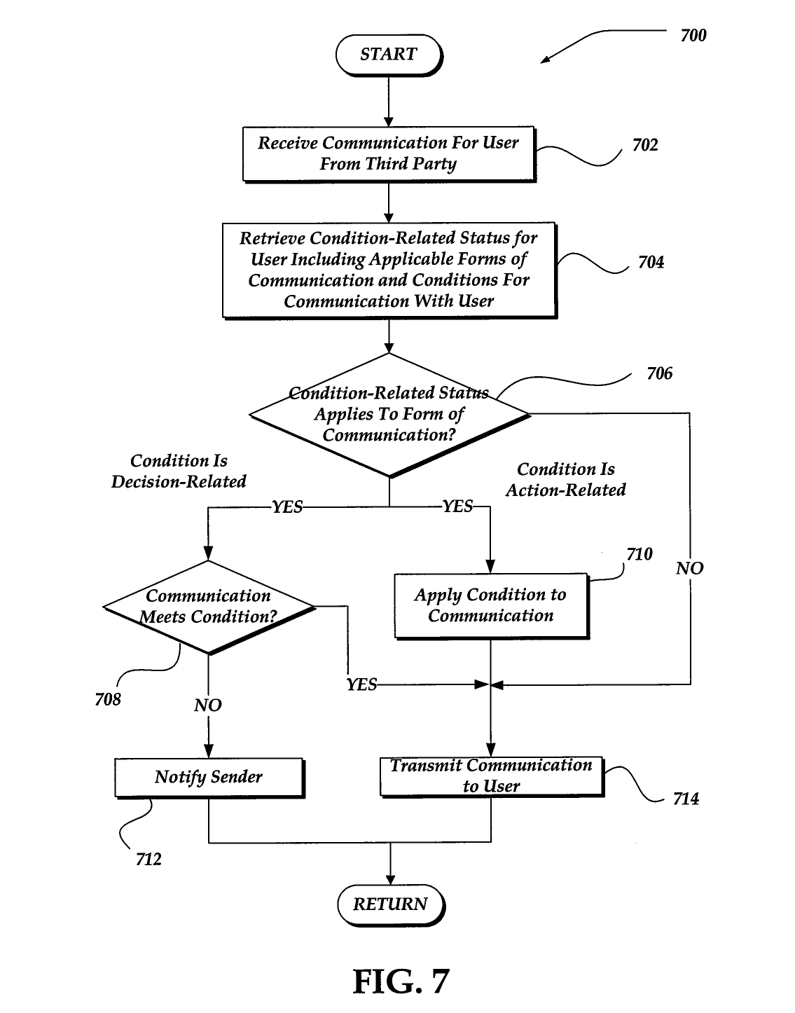

FIG. 7 shows a flow diagram for processing communications to a user when a condition-related status has been previously set by the user. When a third party initiates communication with the user, the system through, for example, communication access server 106 of FIG. 1, retrieves the condition-related status for the user and associated communication access conditions as shown in box 704. Next, the system determines whether the condition-related status applies to the communication. If not, then the system transmits the communication to the user as shown in block 714. If the condition-related status does apply to the form of communication, then the system will process the communication in accordance with the communication access conditions.

The communication access conditions may be decisional, such as a certain condition must be met for a communication to be sent to the user. Examples of such decisional conditions would be such things as limiting communications based on the location or identity of the sender, the time of day, type of communication, and the like. If the communication condition is decisional, the system will determine whether the condition is met or not as shown by block 78 and either transmit the communication to the user as shown in block 714 or take other action such as notifying the sender of the failure to reach the user as indicated in block 712.

In one embodiment, a person may desire that all communications from a certain location, for example a hospital, receive the highest level of priority. This would include all calls, e-mails, text messages and instant messages within the vicinity of the hospital (garnered from proximity to cellular towers or from GPS information). A condition-related status may be created and set for the user which would provide immediate notification of such communications, but delayed notification of all remaining communications. In another embodiment, all calls from a particular area code may be limited during a particular time frame.

The communication access conditions may be action-related. If the condition is action-related, when the condition-related status applies to the communication the action will be taken by the system as shown in block 710. As an example of an action-related communication access condition, on receiving a cellular phone call to a user, the system may first determine whether the battery on the user's cellular phone contains sufficient charge to receive the call. If the battery charge is insufficient, the system may send an alternative form of communication to the user such as an instant message regarding the identity of the caller.

The communication access conditions may be a mixture of decisional conditions and action-related conditions.

The condition-related status may be a default set by the system, such as a default “unavailable” which would prohibit all communications with the user or “available” which would permit all communications with the user. A status based on routines derived by the system may be, for example, based on a physical location of the user's mobile device. The status may be that the user is “imminently arriving” if the physical location of the user's mobile device is within a certain distance of a particular location. The status may be updated by the system periodically, for example by providing an estimation of an arrival time, which may be “10 minutes away” or “arriving at 10:04 am”.

As yet another example, a user may be driving a car but does not have a hands-free option for their cellular telephone. In such a situation, the system can create an automatic default in which it is determined that the cellular telephone is moving at a certain rate without a hands-free operation option (by comparing successive GPS locations over time, or tracking cellular tower connections over time, to identify motion that may indicate travel within a vehicle) and a condition-related status is automatically set for the user, for example, “Driving w/o Hands-Free.” The communication access condition may be set that all communications are routed to e-mail or some other form that does not involve use of the cellular telephone while driving.

A user may create the status category based on specific requirements. As an example, an employer for a delivery company may wish to limit all calls for its truck drivers except for those calls between drivers or from the delivery company for the time between 9:00 am and 5:00 pm. All forms of communication may be directed to voicemail or e-mail except those between drivers or from the company. As another example, a user may set up an “in a meeting” status that has the communication condition that the only communication sent to the user is e-mails, such that all phone calls, text messages, and other forms of communication are blocked or re-routed to e-mail.

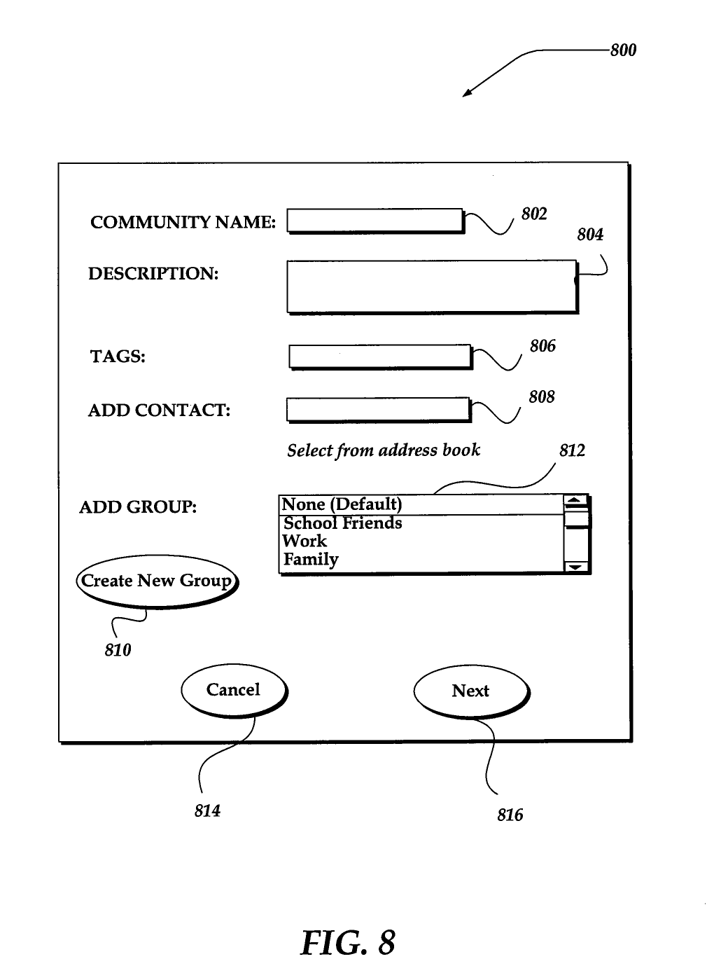

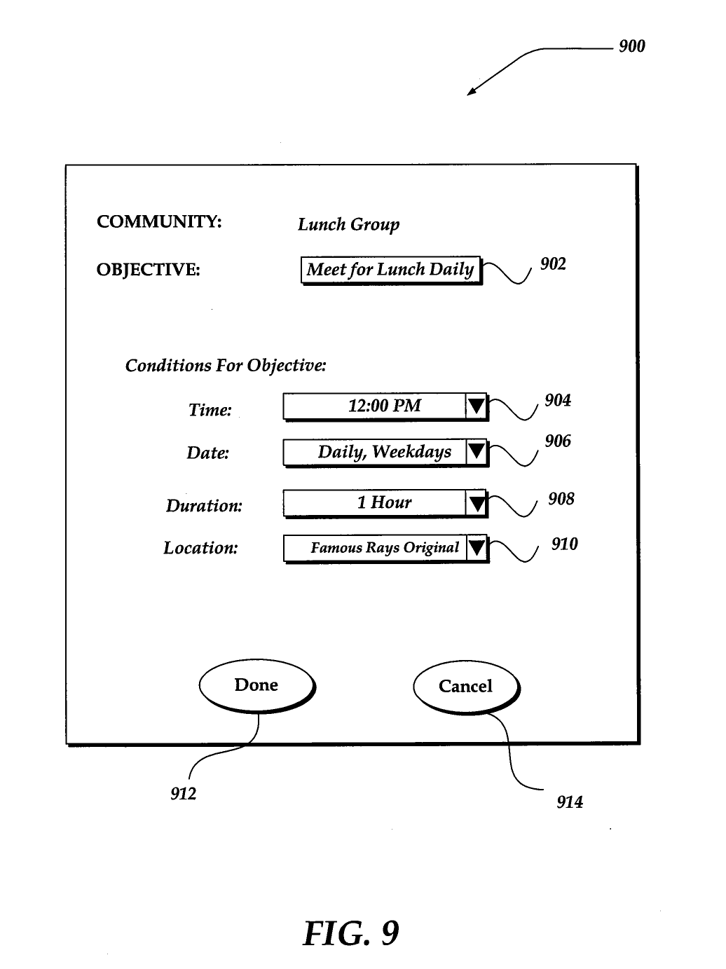

An alternative embodiment of the invention is shown in FIGS. 8, 9 and 10. As shown in FIG. 8, the user defines a community name in text entry block 802, a description of the community in text entry block 804 and members for the community in entry blocks 806 through 812. After completing the entries, the user clicks next button 816. In FIG. 9, the user may define the objective of the community. In this non-limiting example, the objective of the group is to meet for lunch as shown in text entry block 902. The user may then set the conditions for the objective, which may be such things as a time, date, duration and location as indicated by selection boxes 904 through 910, respectively. The community information will be saved when the user clicks on done button 912.

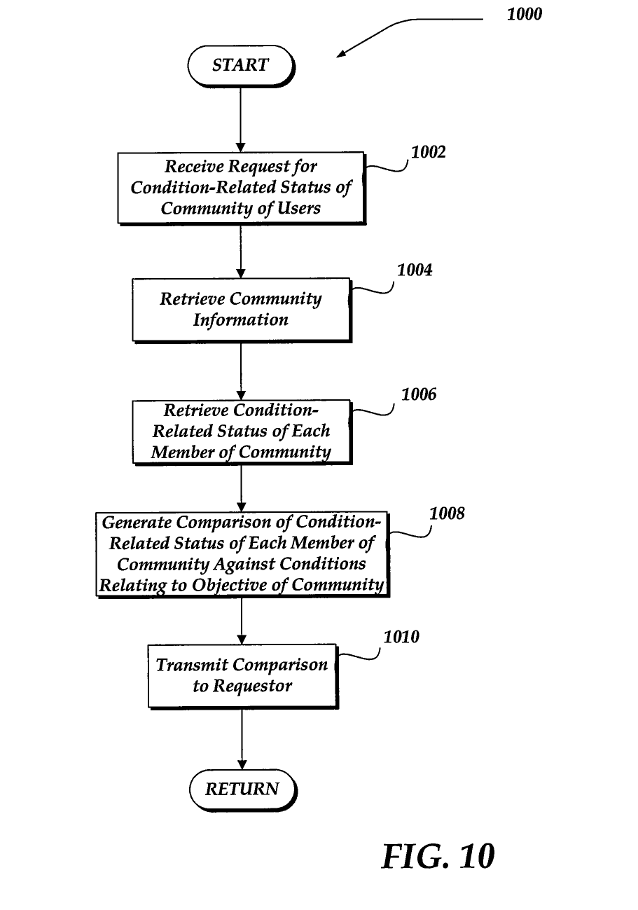

FIG. 10 shows a flow diagram for using condition-related statuses of a community of users to determine the status of the members of the community against a common objective. The process is initiated by a user initiating an inquiry to determine the status of the community with respect to the common objective of the community as shown in block 1002. Alternatively, the system itself may initiate the action based on time, a change in status of a user or other objective criteria relating either to the community members or common objective. The system would then retrieve the community information as shown in block 1004. This community information may include the identity of the community members and the conditions for the common objective of the community. In block 1006, the system determines the condition-related status of each member of the community and then compares the condition-related status against the conditions of the objective of the community. This comparison may then be transmitted to the user as shown in block 1010.

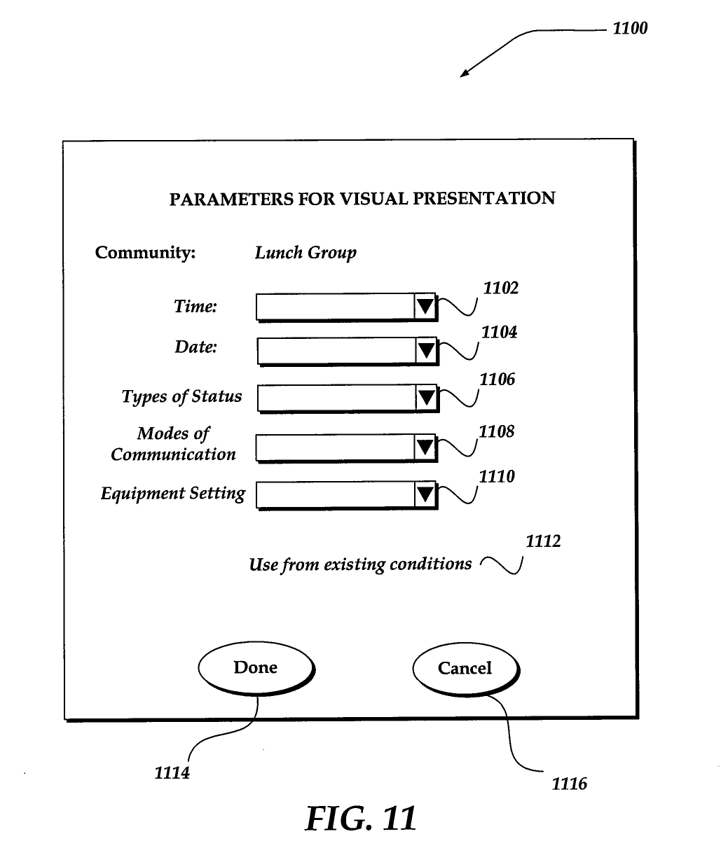

The comparison may be presented in any number of formats. FIG. 11 shows one embodiment of a user selecting the visual parameters for presentation. The user may select the time and date of the particular goal, which in this case is a daily lunch meeting during the work week, as shown in selection boxes 1102 and 1104. The user may select the types of condition-related statuses to be shown. Alternatively, the user may click on the selectable text 1112 to have the system use the existing conditions for the visual display.

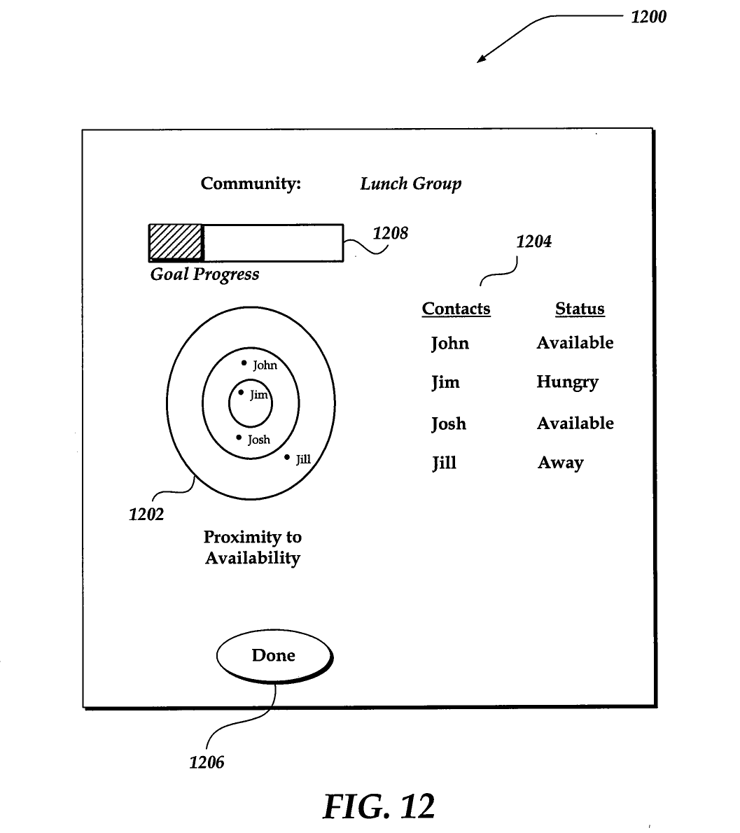

An example of using condition-related statuses of a community of users to determine the status of the members of the community against a common objective would be where a group of friends like to have lunch together. The community may be defined as “lunch group” which has a number of members. The condition-related status of the user may be “hungry”, “available” or “away.” A first user may use the system to determine who within the group is available to go to lunch. On receiving a communication from one of the community to determine the status, the system may take the action of checking the condition-related status of all of the members of the group and forward to one or more users the status of each person, as to whether they are available for lunch or not. In this example, there is no specific time set for the common objective but the objective will be met when a certain number of community members have the same status. One example of an embodiment of a visual display for the community objective is shown in FIG. 12. The contacts and their status are shown in the status column display 1204. The same information may be presented graphically by proximity to goal display 1202. In one embodiment, progress to the goal may also be visually displayed using a bar, such as progress bar 1208, indicating a percent towards, or percent remaining to accomplish the goal. It should be noted, that progress bar 1208 might also indicate a time remaining, where time might be relevant. Thus, progress bar 1208 is not limited to percentage representation, and other progress representations may be employed.

In any event, the system may keep track of the condition-related status, communication access conditions, communications and other information relating to users of the system. The system may keep track of the identity of the party initiating communication, length of the communication, location of both parties during the communication, it may also gather keywords, tags, descriptions, and other user guided content. The system may track the duration and frequency of status conditions and groups that use such statuses and access conditions. This information may be stored in communication access server 106, database 114, data storage 244, or any other storage devices or methods. This information may then be used by the system for various different purposes. For instance, the system may make suggestions for a new condition-related status based on the information tracked by the system. The system may track patterns of the user, and create statuses and related conditions after a designated number of similar patterns from a user. The system may alert or present the user of the proposed new condition-related status. As one example, if the system determines that a user does not communicate via text messaging or phone after 6 pm each day, but does communicate via e-mail, the system may suggest to the user a new condition-related status in which all communications except for e-mail be restricted after 6 pm.

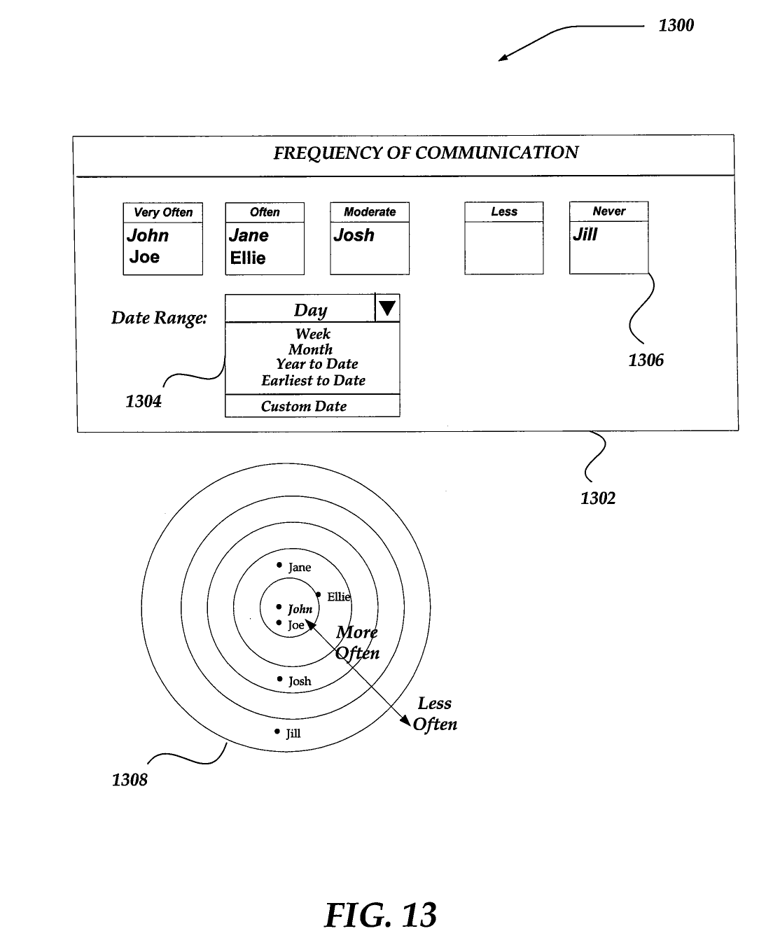

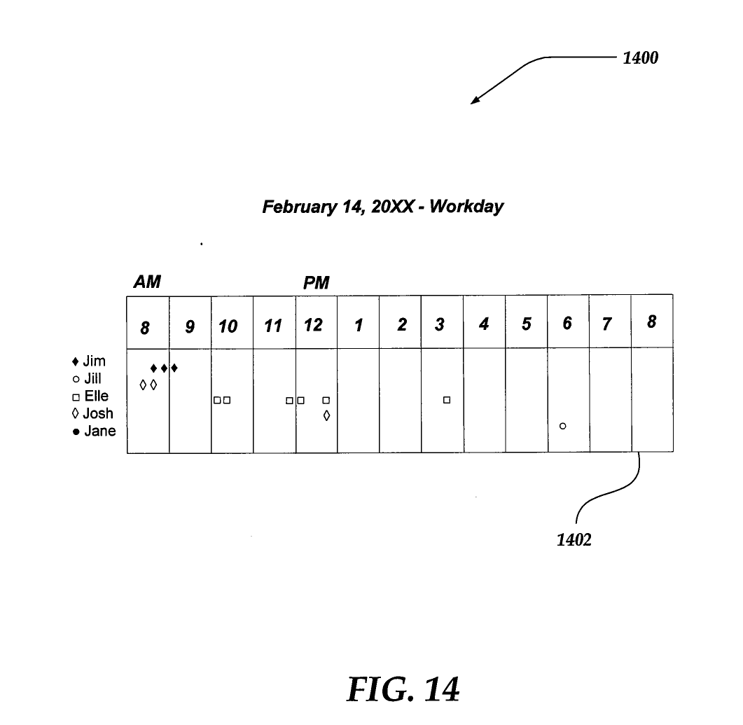

The collected information may also be presented graphically to the user. This can permit the user to determine trends and behavior. One example of a graphic for the frequency of communication with a particular user is shown in FIG. 13. The system may collect information regarding the various forms of communication to a user from various individuals over a period of time. The system may then present a text graphic showing the frequency of communications during that time as shown in box 1302. The date range may be set by a drop down selection as shown by entry box 1304. The summary of the frequency of contact, broken down by contacting individual, is shown by chart 1306. The system may also present an alternative graphical representation as depicted in contact frequency chart 1308. For example, in one embodiment, the closer the contact's name is to the center of the graph, the greater the frequency of contact. From these representations, the user can obtain information about communication trends. A second form of graphic for showing frequency of contact is shown in FIG. 14. FIG. 14 shows the contact during one particular workday between a group of individuals. This type of graphic can show information about group dynamics.

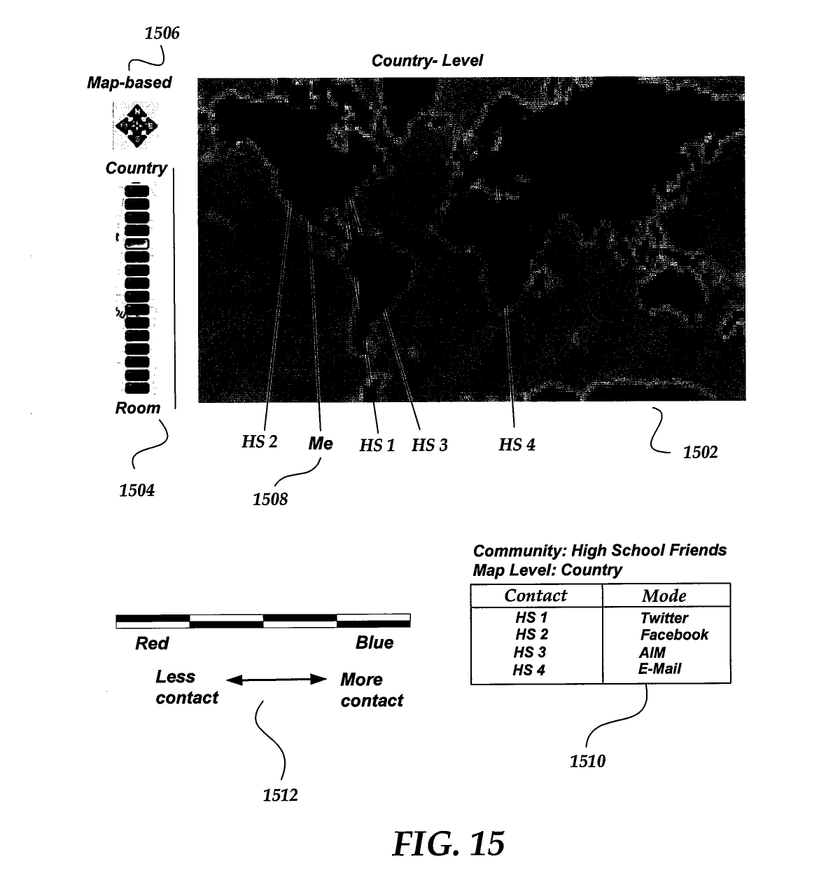

The potential graphics are not limited to frequency of communication, but can extend to any information collectible by the system. As just a few examples, the system may collect the physical locations of the parties to the communication and provide geographical map 1502 as shown in FIG. 15. The display can provide the location 1508 of the user and the locations 1514 of each of the persons communicating with the user. The resolution of the display may be controlled by the interface 1504, which in this instance ranges from the room-level to the country-level scale. The display may also be movable by another interface such as 1506 to move the display in any direction. The system may also collect information about the most prevalent form of communication from each user, as shown by the chart 1510, and the frequency of communication may also be displayed in various manners, which in this instance is based on color. The display of the particular person is redder with the less communication that the person has with the user, and more blue with the more frequent communication contact with the user.

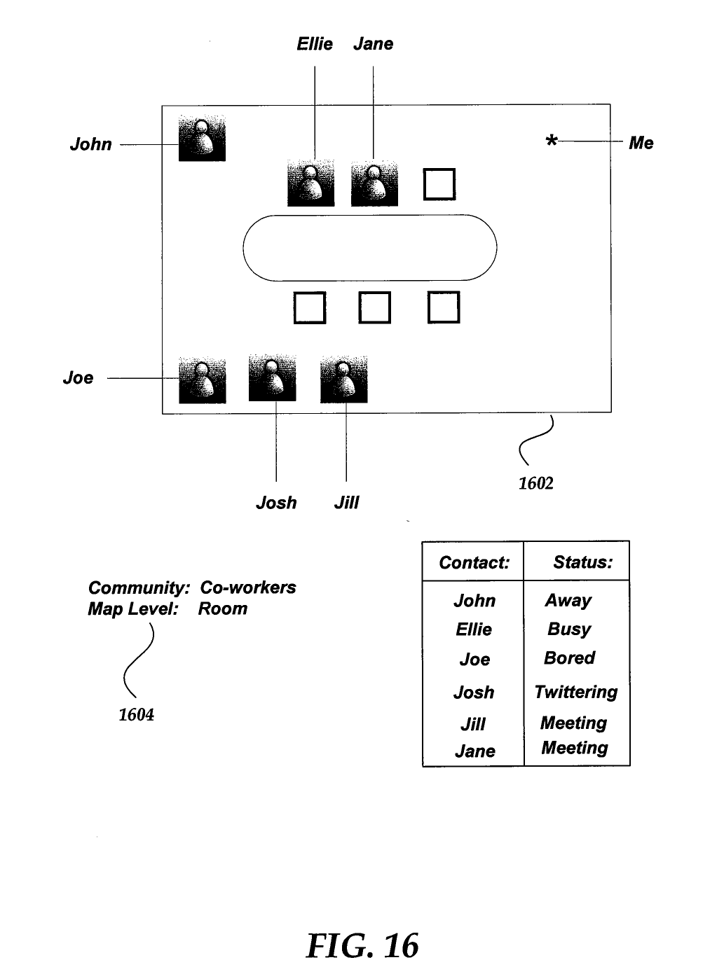

A graphic showing a higher resolution is shown in FIG. 16. In this example, the status and location of each user is shown. The resolution in this instance is room-level, showing a number of individuals in a meeting. Each user is provided with a condition-related status. The condition-related status can be used to target the individual for particular activities. As one example, when a user has a status that indicates susceptibility to alternate activities, the system can prompt the user to engage in such activities. For instance, if a user is “bored” during a meeting, then the system can target the user with games to play on the user's mobile device. Similarly, the ‘bored’ user may also be presented with what others in the meeting might be doing, see if they are available for chatting, or participating in the game, or the like.

The system allows users to garner the communication availability of multiple individuals in a single entity, that is, a group or community. The invention also allows the system to discern flocking or herd behavior of entity groups engaged in similar activities, is social contexts, within temporal frameworks or spatial proximity, and provide communication recommendations to users. The system may gather keywords, tags, descriptions or any other user content as a basis for serving up targeted ads. The information gathered by the system can be used by product and branding companies to measure the effectiveness of their advertising or brand awareness. For example, a company may require all users to submit their satisfaction level for the product as a status, perhaps based on incentives to the users in doing so. The users may change their status at anytime, and view the satisfaction statuses of all other users at any time.

It will be understood that each block of the flowchart illustrations above, and combinations of blocks in the flowchart illustrations, can be implemented by computer program instructions. These program instructions may be provided to a processor to produce a machine, such that the instructions, which execute on the processor, create means for implementing the actions specified in the flowcharts' block or blocks. The computer program instructions may be executed by a processor to cause a series of operational steps to be performed by the processor to produce a computer-implemented process such that the instructions, which execute on the processor to provide steps for implementing the actions specified in the flowcharts' block or blocks. The computer program instructions may also cause at least some of the operational steps shown in the blocks of the flowcharts to be performed in parallel. Moreover, some of the steps may also be performed across more than one processor, such as might arise in a multi-processor computer system. In addition, one or more blocks or combinations of blocks in the flowchart illustrations may also be performed concurrently with other blocks or combinations of blocks, or even in a different sequence than illustrated without departing from the scope or spirit of the invention.

Accordingly, blocks of the flowchart illustrations support combinations of means for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems, which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected is:

1. A network device, comprising:
a transceiver to send and to receive a communication over a network; and
a processor that is operative to enable actions, including:
receiving from a user, a communication access condition arranged to control at least one communication to the user;
automatically generating at least one other communication access condition receiving a communication directed to at least the user;
determining a condition-related status of at least the user;
retrieving the user received and the automatically generated communication access conditions for the condition-related status; and
processing the communication to at least the user in accordance with the communication access conditions based on the condition-related status of at least the user.

2. The network device of claim 1, wherein the automatically generated at least one other communication access condition comprises at least one communication access condition automatically generated based on an analysis of a communication behavior or routine pattern of at least the user.

3. The network device of claim 1, wherein the received communication access condition comprises at least one of duration condition, a location condition, a communication mode, or a condition on a communication device of at least the user.

4. The network device of claim 1, where the processor is operative to enable actions, further including:
receiving a definition of a group of other users for which to apply the communication access conditions;
receiving another communication directed to at least one other user in the group of other users;
determining other condition-related statuses for the at least one other user in the group of other users;
processing the other communication to at least one other user in the group of other users based on the other condition-related statuses and the communication access conditions.

5. The network device of claim 1, wherein the processor is further operative to enable actions, including:
storing information regarding the communication; and
generating a graphical representation of the information regarding the communication.

6. The network device of claim 5, wherein the information regarding the communication relates to an attribute of a source of the received communication or a frequency of contact between the user and the source of the communication.

7. A processor readable storage medium that includes data and instructions wherein the execution of the instructions on a network device enables actions, comprising:
receiving from a user a communication access condition for at least one given condition-related status usable to control at least one communication;
receiving a communication directed to the user from a communication source;
determining a condition-related status of the user; and
processing the communication to the user in accordance with the communication access condition associated with the determined condition-related status.

8. The processor readable storage medium of claim 7, wherein the communication access condition is based on at least one of a contextual condition, communication mode, or a condition of a client device.

9. The processor readable storage medium of claim 7, wherein processing the communication further comprises at least one of:
selectively forwarding the communication to the user based on the communication source or location of the communication source;
selectively forwarding the communication to the user based on the communication source and a time of day; or
selectively rerouting the communication from a first communication mode to a second communication mode based on a configuration of a client device of the user and a location of the user.

10. The processor readable storage medium of claim 7, wherein the execution of the instructions enable actions, further including:
receiving identification of a plurality of members of a group;
receiving another communication access condition that is associated with at least one member of the group;
receiving another communication directed to at least one member in the group;
determining another condition-related status of the at least one member in the group for which the other communication is directed; and
processing the other communication to the at least one other member in the group based on the other communication access condition associated with the condition-related status of the at least one other member in the group.

11. The processor readable storage medium of claim 10, wherein the execution of the instructions further enable actions, including:
receiving at least one communication goal associated with the group; and
based on a plurality of communications between members in the group and a plurality of condition-related statuses of members in the group, providing a visual representation indicating progress towards the communication goal of the group.

12. The processor readable storage medium of claim 11, wherein at least one condition for the communication goal is received from at least one member in the group.

13. The processor readable storage medium of claim 7, wherein the execution of the instructions further enable actions, including:
receiving a request to determine the condition-related status of the user in relation to a goal; and
providing a visual representation of the condition-related status of the user with respect to the goal.

14. The processor readable storage medium of claim 7, wherein the execution of the instructions further enable actions, including:
automatically monitoring a communication behavior of the user;
analyzing the monitored communication behavior to identify one or more communication patterns; and
creating at least one other communication access condition based on the analysis.

15. A method operating on one or more computing devices for managing communications over a network, comprising:
receiving a communication directed to a user from a communication source through one of two or more forms of communication;
determining a condition-related status of the user; and
selectively providing the communication to the user in accordance with the communication access condition associated with the condition-related status.

16. The method of claim 15, wherein the communication access condition identifies a condition upon which to convert the received communication from one communication protocol to another communication protocol.

17. The method of claim 15, wherein the communication access condition is automatically modified based on a system generated access condition.

18. The method of claim 15, further comprising:
monitoring a communication behavior of the user;
creating another communication access condition based on a determined pattern identified from the monitored communication behavior; and
alerting the user of the created other communication access condition when the user is detected in engaging in another communication that is related to the determined pattern.

19. The method of claim 15, further comprising:
receiving from the user identification of members in a group;
receiving a communication goal for the group;
receiving at least one communication access condition for the communication goal;
providing to at least one of the user or members in the group, a visual representation of progress towards the communication goal based on tracking of communications of the user and members in the group.

20. The method of claim 19, wherein tracking of the communications further comprises providing to the user or at least one member of the group a recommendation for a change to the communication goal.
